(19) United States
(12) Patent Application Publication
(10) Pub. No.: US 2025/0390566 A1
(43) Pub. Date: Dec. 25, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: Miho ISHIGAMI, Tokyo (JP); Masakazu FUJIKI, Kanagawa (JP)

(21) Appl. No.: 19/225,040

(22) Filed: Jun. 2, 2025

(30) Foreign Application Priority Data
Jun. 20, 2024 (JP) 2024-099350

(51) Int. Cl. G06F 21/32; G06V 40/12; G06V 40/18

(52) U.S. Cl. CPC G06F 21/32; G06V 40/197; G06V 40/1365

(57) ABSTRACT

An information processing apparatus comprises a user identification unit configured to identify a user that captured an image by using an image capturing apparatus; an affiliation identification unit configured to identify the affiliation of the user and acquire attribute information of the affiliation of the user based on personal identification information that identifies individual identity of the user identified by the user identification unit; and a recording unit configured to record attribute information of the affiliation of the user in association with the image captured by the user.

### BACKGROUND

### Technical Field

The present disclosure relates to an information processing apparatus, an information processing method, a storage medium, and the like.

### Description of the Related Art

In recent years, cameras provided with authenticity guarantee technologies for captured images are beginning to be sold for the purpose of guaranteeing that images are captured images rather than images created by AI (artificial intelligence). The authenticity guarantee technologies are realized by, for example, providing a unique number assigned to each camera to a captured image in a tamper-proof manner. In addition to these technologies, providing user information to captured images in a tamper-proof manner (user authenticity guarantee) is desired.

Conventionally, there is a method for performing personal authentication of a user (person) of an information processing apparatus. Japanese Patent Application Laid-Open No. 2024-002562 describes performing personal authentication by using an eye image of a user looking into a viewfinder. User authenticity guarantee can be realized in combination with such a method of performing personal authentication of a user of an information processing apparatus (camera).

However, according to the method of Japanese Patent Application Laid-Open No. 2024-002562, information identifying an organization (affiliation) configured by a plurality of persons including the camera user specified by personal authentication cannot be recorded in association with an image.

### SUMMARY

The present disclosure is made in view of such circumstances, and one of the objectives of the present disclosure is to provide an information processing apparatus configured to record information identifying the affiliation of a specified camera user in association with an image.

In order to achieve the above-described objective, an information processing apparatus according to one aspect of the present disclosure comprises a user identification unit configured to identify a user that captured an image by using an image capturing apparatus; an affiliation identification unit configured to identify the affiliation of the user and acquire attribute information of the affiliation of the user based on personal identification information that identifies individual identity of the user identified by the user identification unit; and a recording unit configured to record attribute information of the affiliation of the user in association with the image captured by the user.

Further features of the present disclosure will become apparent from the following description of exemplary embodiments (with reference to the attached drawings).

### BRIEF DESCRIPTION OF THE DRAWINGS

FIGS. 1A to 1C are diagrams exemplifying an exterior and the like of a camera according to a First Embodiment.

FIG. 2 is a diagram exemplifying a configuration of a camera according to the First Embodiment.

FIG. 3 is a block diagram of an electrical configuration of a camera according to the First Embodiment.

FIG. 4 is a functional block diagram of a camera according to the First Embodiment.

FIG. 5 is a flowchart showing processing in a camera according to the First Embodiment.

FIG. 6 is a diagram showing an example of a data structure recorded by a recording unit according to the First Embodiment.

FIG. 7 is a diagram showing an example of a data structure recorded by a recording unit according to the First Embodiment.

FIG. 8 is a diagram showing an example of a data structure recorded by a recording unit according to a Second Embodiment.

FIG. 9 is a diagram showing an example of a data structure recorded by a recording unit according to a Third Embodiment.

FIG. 10 is a diagram showing an example of a data structure recorded by a recording unit according to a Fourth Embodiment.

FIGS. 11A to 11E are diagrams showing examples of user interfaces displayed on an operation member of a camera according to a Fifth Embodiment.

### DESCRIPTION OF THE EMBODIMENTS

Hereinafter, preferred embodiments of the present disclosure will be explained with reference to the attached drawings. The present disclosure is not limited to the situations explained below, and embodiments that align with the spirit of the present disclosure are applicable. In addition, in each of the figures, the optical axis direction of the lens is defined as the Z-axis, a predetermined direction in a plane perpendicular to the Z-axis is defined as the X-axis, and a direction perpendicular to the X-axis is defined as the Y-axis.

### First Embodiment

In the present embodiment, as an example of applying the present disclosure to a camera, a method of acquiring identification information of the affiliation of a camera user and recording the acquired identification information in association with an image captured by the camera will be explained.

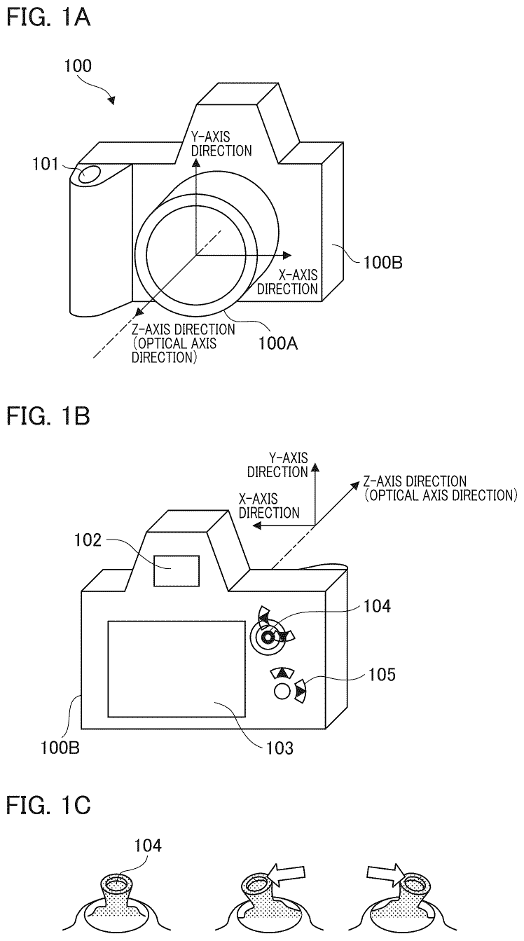

FIGS. 1A to 1C are diagrams exemplifying a hardware configuration of a camera (image capturing apparatus) 100 that is an apparatus in which the present embodiment is implemented. Specifically, FIGS. 1A to 1C are exterior views of a camera 100 (interchangeable lens camera) that is a digital still camera in the present embodiment. FIG. 1A is a front perspective view of the camera 100. FIG. 1B is a rear perspective view of the camera 100. FIG. 1C is a diagram showing an operation example of an operation member 104 that the camera 100 includes.

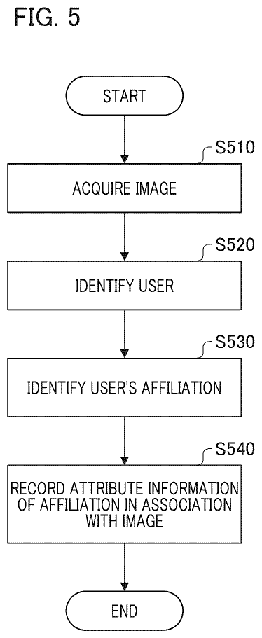

Hereinafter, a CPU 212 to be described later functions as an information processing apparatus that executes each processing shown in FIG. 5 and the like. In that case, the camera 100 comprises an information processing apparatus therein. Hereinafter, although an example in which the functions of the information processing apparatus are included in the camera 100 will be explained, a part or all of the functions of the information processing apparatus may be outside the camera 100. That is, an information terminal such as a PC or a tablet that is an external apparatus connected to the camera 100 by wire or wirelessly can function as an information processing apparatus in the present embodiment. It should be noted that the camera 100 may function as an information processing apparatus that executes each processing to be explained later.

As shown in FIG. 1A, the camera 100 comprises an image capturing lens unit 100A and a camera body 100B. On the camera body 100B, a release button 101 serving as an operation member that accepts an image capturing operation from a user (operator) is arranged. As shown in FIG. 1B, on the back surface of the camera body 100B, an eyepiece lens 102 (viewfinder) into which the user peers for the purpose of viewing a later-described display device 214 (display panel) that is included in the camera body 100B is arranged. On the back surface of the camera body 100B, an operation member 103, an operation member 104, and an operation member 105 that accept various operations from the user are arranged. For example, the operation member 103 is a touch panel (input device) that accepts touch operation. In addition, the operation member 104 is an operation lever that can be pushed down in each direction. In addition, the operation member 105 is a 4-way key that can be pushed in each of four directions. The operation member (touch panel) 103 comprises a display panel (for example, a liquid crystal panel), and has a function of displaying images on the display panel.

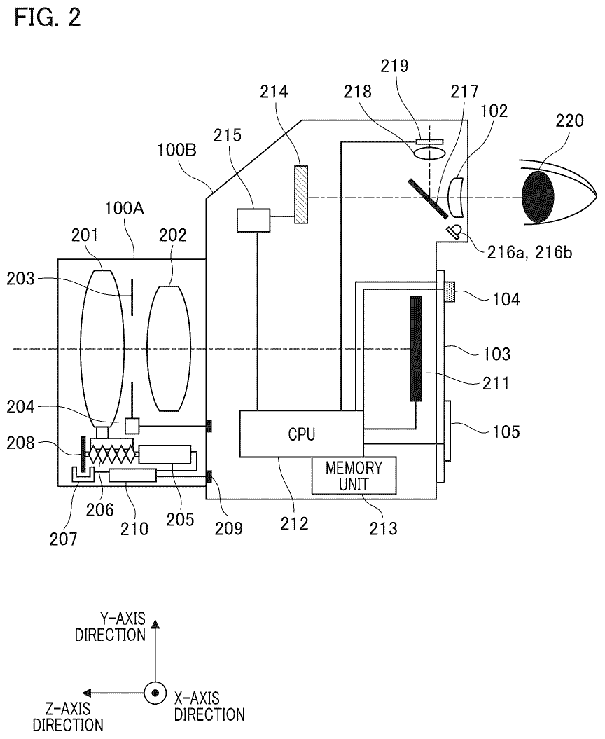

FIG. 2 is a cross-sectional view of the camera 100 cut in a YZ plane formed by the Y-axis and the Z-axis shown in FIG. 1A, and is a diagram illustrating an example of the internal configuration of the camera 100. The image capturing lens unit 100A comprises a lens 201, a lens 202, an aperture 203, an aperture drive unit 204, a lens drive motor 205, a lens drive member 206, a photo coupler 207, a pulse plate 208, a mount contact 209, and a focus adjustment circuit 210.

The lens drive member 206 is a member that includes a drive gear. The photo coupler 207 detects rotation of the pulse plate 208 that interlocks with the lens drive member 206 and the photo coupler 207 transmits the detection to the focus adjustment circuit 210. The focus adjustment circuit 210 drives the lens drive motor 205 based on information from the photo coupler 207 and information from the camera body 100B (information of lens drive amount), and changes the in-focus position by moving the lens 201. The mount contact 209 serves as an interface between the image capturing lens unit 100A and the camera body 100B. It should be noted that, although for simplicity, two lenses 201 and 202 are shown, in reality, more than two lenses are included in the image capturing lens unit 100A.

The camera body 100B includes an image capturing element 211, the CPU 212, a memory unit 213, the display device 214, and a display device drive circuit 215. The image capturing element 211 is arranged on a planned image-forming plane of the image capturing lens unit 100A. The image capturing element 211 is configured by an image sensor such as a CCD (Charge Coupled Device) or CMOS (Complementary Metal Oxide Semiconductor).

The CPU (processor) 212 is a central processing unit of a microcomputer, and controls the entire camera 100 by executing a control program stored in the memory unit 213. That is, the CPU 212 comprehensively controls each component in the camera 100.

The memory unit 213 is a storage medium configured by volatile memory such as RAM (Random Access Memory), nonvolatile memory such as ROM (Read Only Memory), and the like, and stores various information related to the camera 100. For example, the memory unit 213 stores images captured by the image capturing element 211, setting values such as various parameters and ISO sensitivity, and the like, image capturing mode, and various correction data, and the like. In addition, the memory unit 213 stores a control program for controlling operation of the camera 100, variables, constants, and the like. In addition, the memory unit 213 may have a secondary storage apparatus (not shown) as another storage medium, and the secondary storage apparatus may be included in the memory unit 213. The secondary storage apparatus is, for example, a rewritable storage apparatus (storage medium) such as a hard disk or a flash memory, and the like, and is configured to store received data via a communication unit (communication device) 307 to be described later.

The display device 214 displays various information on a screen (display surface) of the display device 214. For example, the display device 214 is a liquid crystal panel and displays a captured image (subject image) on the screen. The display device drive circuit 215 drives the display device 214. The user can see the screen of the display device 214 through the eyepiece lens 102.

The camera body 100B comprises a light source 216a, a light source 216b, a light splitter 217, a light receiving lens 218, and an eye image capturing element 219. The light source 216a and the light source 216b are light sources that have been conventionally used in single-lens reflex cameras for the purpose of detecting line of sight from a relationship between a reflection image (corneal reflection image) due to corneal reflection of light and a pupil. In addition, the light source 216a and the light source 216b are also light sources for illuminating an eyeball 220 of the user looking into the viewfinder (eyepiece lens 102). For example, the light source 216a and the light source 216b are infrared light-emitting diodes that emit infrared light that is imperceptible to the user, and are arranged around the eyepiece lens 102. An optical image of the illuminated eyeball 220 (eye optical image: an optical

image due to reflected light emitted from the light source 216a and the light source 216b and reflected by the eyeball 220) passes through the eyepiece lens 102, and is reflected by the light splitter 217. Then, the eye optical image forms an image using the light receiving lens 218 on the eye image capturing element 219 on which a plurality of photoelectric conversion elements are arranged two-dimensionally. The light receiving lens 218 positions the pupil of the eyeball 220 and the eye image capturing element 219 in a conjugate image-forming relationship. Using a predetermined algorithm to be described later, line of sight of the eyeball 220 is detected (information related to the line of sight is acquired) from a position of the corneal reflection image in the eye optical image formed on the eye image capturing element 219. For example, as information related to the line of sight, at least one of information indicating a line-of-sight direction (direction of the line of sight) and information indicating a viewpoint (position at which the line of sight is directed) on the screen of the display device 214 is obtained. The viewpoint can be considered as a position at which the user is looking, or can be considered as a line-of-sight position.

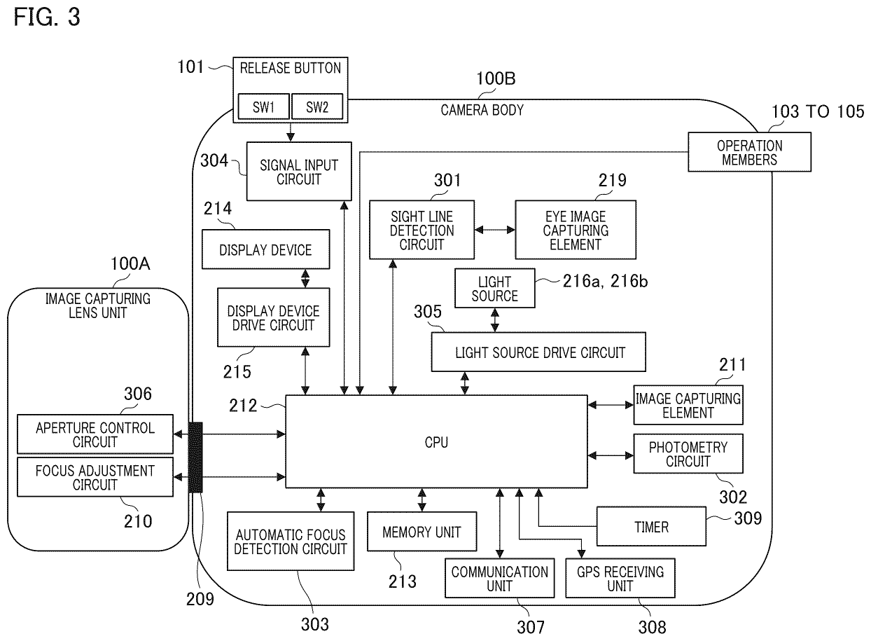

FIG. 3 is a block diagram showing an electrical configuration in the camera 100. A line-of-sight detection circuit 301, a photometry circuit 302, an automatic focus detection circuit 303, a signal input circuit 304, the display device drive circuit 215, and a light source drive circuit 305 are connected to the CPU 212. The CPU 212 transmits a signal via the mount contact 209 to a focus adjustment circuit 210 that is arranged in the image capturing lens unit 100A and to an aperture control circuit 306 that is included in the aperture drive unit 204 in the image capturing lens unit 100A.

The memory unit 213 that is associated with the CPU 212 further has a storage function of an image capturing signal from the image capturing element 211 and the eye image capturing element 219, and a storage function of a line-of-sight correction parameter to be described later.

The line-of-sight detection circuit 301 performs A/D conversion on an output (an eye image obtained by performing image capturing of an eye (eyeball 220)) of the eye image capturing element 219 in a state in which the eye optical image forms an image on the eye image capturing element 219, and transmits the result to the CPU 212.

The CPU 212 extracts feature points necessary for line-of-sight detection from the eye image according to a predetermined algorithm to be described later, and detects line of sight of the user from positions of the feature points.

The photometry circuit 302 performs predetermined processing (for example, amplification, logarithmic compression, and A/D conversion) on a signal obtained from the image capturing element 211 serving as a photometry sensor, for example, a luminance signal corresponding to brightness of a subject field, and sends the result to the CPU 212 as subject field luminance information.

The automatic focus detection circuit 303 performs A/D conversion on signals from a plurality of detection elements (plurality of pixels) that are included in the image capturing element 211 and are used for phase difference detection, and sends the converted signals to the CPU 212. The CPU 212 calculates a distance to a subject corresponding to each focus detection point from signals of the plurality of detection elements. Since this is a known technology known as image capturing surface phase difference AF, an explanation thereof will be omitted.

A switch SW1 and a switch SW2 are connected to the signal input circuit 304. The switch SW1 is a switch for starting an image capturing preparation operation (for example, photometry and distance measurement) of the camera 100, and turns ON at a first stroke of the release button 101. The switch SW2 is a switch for starting an image capturing operation, and turns ON at a second stroke of the release button 101. ON signals from the switch SW1 and the switch SW2 are input to the signal input circuit 304, and are transmitted to the CPU 212. Line-of-sight detection may be started in a case in which the switch SW1 turns ON. The light source drive circuit 305 drives the light source 216a and the light source 216b.

Furthermore, the operation members 103 to 105 are also connected to the CPU 212. When a user operates the operation members 103 to 105, the operation members 103 to 105 output operation signals corresponding to operations from the user to the CPU 212, and the CPU 212 performs processing (control) corresponding to the operation signals. For example, the CPU 212 moves a frame (item, index) displayed at a viewpoint according to the operation signals.

The communication unit 307, a GPS reception unit 308, and a timer 309 are also connected to the CPU 212. The communication unit 307 performs wireless communication with information devices such as a smartphone, a tablet terminal, a smartwatch, a PC, and the like owned by the user, and acquires GPS position information of the information device. Although the wireless communication is assumed to be Wi-Fi, Bluetooth, or the like, the wireless communication is not limited thereto. The GPS reception unit 308 receives radio waves from GPS satellites and acquires GPS position information of the camera 100. The timer 309 outputs a current time.

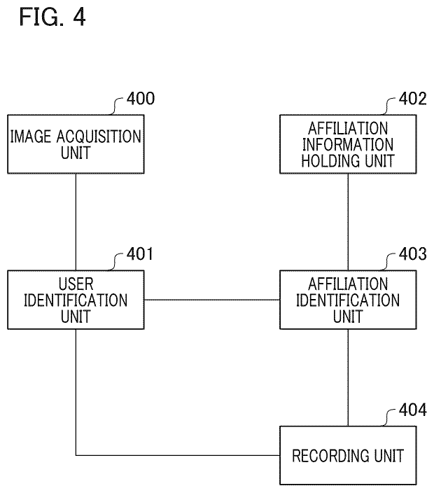

FIG. 4 is a block diagram showing a functional configuration in the camera 100 according to the present embodiment. In other words, FIG. 4 is a diagram showing a module configuration of the information processing apparatus (CPU 212) according to the present embodiment. The information processing apparatus is configured by, as function units thereof, an image acquisition unit 400, a user identification unit 401, an affiliation information storage unit 402, an affiliation identification unit 403, and a recording unit 404. These function units are realized by the CPU 212 executing a program stored in the memory unit 213. Then, the CPU 212 stores execution results of each processing to be described later in a storage medium such as the memory unit 213.

The image acquisition unit 400 acquires an image created by converting an image capturing signal obtained from the image capturing element 211 of the camera 100 into a video signal. The image acquisition unit 400 outputs the acquired image to the recording unit 404. The user identification unit 401 identifies a person (user) using the camera 100 (identifies by authentication). The user identification unit 401 outputs personal identification information corresponding to the identified camera 100 user to the affiliation identification unit 403. The affiliation information storage unit 402 stores attribute information (metadata) that includes at least identification information of an affiliation of the user in association with information identifying the user.

The affiliation identification unit 403 identifies the affiliation of the user identified by the user identification unit 401 based on attribute information stored by the affiliation information storage unit 402. The affiliation identification unit 403 outputs attribute information of the affiliation of the identified user of the camera 100 to the recording unit 404. The recording unit 404 records to the memory unit 213 attribute information that includes identification information of the affiliation of the user determined by the affiliation identification unit 403 in association with the image acquired by the image acquisition unit 400. It should be noted that the recording unit 404 may be configured so as to record to an external data storage device that is removable from the camera 100 in addition to the memory unit 213.

FIG. 5 is a flowchart showing processing in the camera 100 (information processing apparatus) according to the First Embodiment. Hereinafter, processing performed by the camera 100 of the present embodiment will be explained with reference to FIG. 5. Each of the following processing is realized by the CPU 212 of the camera 100 executing a program stored in the memory unit 213. In addition, each step is denoted with “S” at the beginning, thereby omitting the notation of “step”.

In S510, the image acquisition unit 400 acquires an image obtained from the camera 100. The image acquisition unit 400 outputs the acquired image to the recording unit 404. The image acquisition unit 400 may store the acquired image in an external data storage device that is removable from the camera 100. The external data storage device may be a removable recording medium such as an SD card or a CF card, an external storage such as a USB memory connected by wire or wirelessly, or storage in the cloud.

In S520, the user identification unit 401 identifies a person (user) that is currently using the camera 100. That is, the user identification unit 401 identifies a camera user, wherein the camera user is a person currently operating the camera 100 and has captured the image acquired by the image acquisition unit 400 in the present processing. In the present embodiment, as a method for the user identification unit 401 to identify the user of the camera 100, biometric authentication by using eyeball information is performed. Specifically, the user of the camera 100 is identified by performing iris authentication using video of the eyeball 220 of the user of the camera 100 looking into the eyepiece lens 102.

In this context, the user of the camera 100 of the present embodiment registers color pattern information as eyeball information in the memory unit 213 of the camera 100 in advance. Iris pattern information (registrant feature) obtained from the eyeball of the user is recorded in the memory unit 213 in association with (related to) information identifying the user (personal identification information). In addition, the processing of identifying the user of the camera 100 is performed by comparing a registrant feature (color pattern information of the registrant) registered in advance as described above with iris pattern information (user feature) obtained from the eyeball of the user acquired at the time of image capturing. That is, the user identification unit 401 compares the user feature of the user with the registrant feature of the registrant, and in a case in which a similarity is equal to or greater than a predetermined threshold, the user identification unit 401 identifies the person (user) that captured the image acquired in S510 by determining that the user is the registrant. Thereafter, the user identification unit 401 identifies personal identification information corresponding to the identified user of the camera 100. In other words, the personal identification information linked to the registrant feature of the registrant identified as the user of the camera 100 is determined as the personal identification information of the identified user of the camera 100. Thereafter, the user identification unit 401 outputs the determined personal identification information of the user of the camera 100 to the affiliation identification unit 403.

It should be noted that in a case in which a plurality of registrant features are registered, all registered registrant features are compared with the user feature, and the user identification unit 401 determines whether or not there is a registrant feature having a similarity equal to or greater than a predetermined threshold. As a result of this determination, in a case in which a plurality of registrant features having a similarity equal to or greater than the predetermined threshold exist, the user identification unit 401 identifies a person corresponding to the registrant feature having the highest similarity among the plurality of registrant features as the user of the camera 100. It should be noted that in a case in which there is one registrant feature having a similarity equal to or greater than the predetermined threshold, the person corresponding to the registrant feature is identified as the user of the camera 100. Thereafter, the user identification unit 401 identifies personal identification information corresponding to the identified user of the camera 100. In this case as well, as described above, personal identification information linked to the registrant feature identified as the user is determined as personal identification information of the identified user of the camera 100.

It should be noted that although in the above-described explanation, the processing in S520 for identifying the user of the camera 100 is performed by iris authentication, the present disclosure is not limited thereto, and any other method may be used provided that the user can be identified. For example, fingerprint authentication or password authentication may be used.

In S530, the affiliation identification unit 403 identifies the affiliation of the user of the camera 100 identified by the user identification unit 401 in S520 based on attribute information stored by the affiliation information storage unit 402. Specifically, the affiliation identification unit 403 searches a database that associates personal identification information of a registrant recorded in the memory unit 213 with attribute information of the affiliation by using the personal identification information of the user of the camera 100 identified in S520 as a key, and identifies the affiliation of the user. In this manner, attribute information of the affiliation of the identified user of the camera 100 can be acquired. The affiliation information storage unit 402 may function as a database that stores attribute information that includes identification information of the affiliation of the user in correspondence with (in association with) personal identification information that is information identifying the user. It should be noted that in identifying the affiliation of the user of the camera 100, the affiliation identification unit 403 may use the personal identification information output from the user identification unit 401 or may use the personal identification information of the registrant recorded in the memory unit 213. Thereafter, the affiliation identification unit 403 outputs attribute information of the affiliation of the identified user of the camera 100 to the recording unit 404.

In S540, the recording unit 404 records the image acquired in S510 and attribute information of the affiliation of the user of the camera 100 identified in S530 to the memory unit 213. Here, the attribute information of the affiliation of the user of the camera 100 recorded to the memory unit 213 is identification information that uniquely identifies the affiliation of the user. It should be noted that in addition to the memory unit 213, the image and attribute information may be stored in an external data storage device removable from the camera 100.

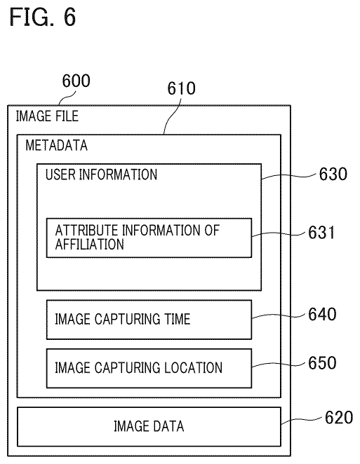

Hereinafter, with reference to FIG. 6, a configuration of data (image and attribute information) recorded by the recording unit 404 in the processing of S540 in the First Embodiment will be explained. FIG. 6 is a diagram showing a configuration of data recorded by the recording unit 404 in processing of S540 in the First Embodiment.

Specifically, in S540, the recording unit 404 records to the memory unit 213 an image file 600 that is data that includes the image acquired by the image acquisition unit 400 in S510 and the attribute information of the affiliation of the user identified by the affiliation identification unit 403 in S530. The image file 600 is configured by image data 620 and metadata 610, wherein the image data 620 is an image acquired by the image acquisition unit 400 in S510. The metadata 610 is data that includes attribute information 631 of the affiliation of the user as user information 630.

It should be noted that the metadata 610 may include information with respect to an image capturing time 640 and information with respect to an image capturing location 650 in addition to the attribute information 631 as shown in FIG. 6. The information with respect to the image capturing time 640 is acquired by using the timer 309 of the camera 100 and is information of a time at which video input from the image capturing element 211 was actually recorded to the memory unit 213. In addition, the information with respect to the image capturing location 650 is information of longitude and latitude acquired by using the GPS reception unit 308 of the camera 100.

As described above, the camera 100 having the information processing apparatus (CPU 212) of the First Embodiment enables information identifying an organization configured by a plurality of persons to be recorded by associating with an image captured by the user of the camera 100.

### Modification Example 1

In the First Embodiment, as described above, identification information of the affiliation was recorded in association with an image captured by the user of the camera 100 as attribute information of the affiliation of the user of the camera 100. In this context, if attribute information is attribute information related to the affiliation of the user of the camera 100, the attribute information is not limited to identification information of the affiliation. For example, the attribute information may be a name of an organization. In addition, the affiliation may be a corporation or a department within a corporation, or may be a group of individuals without corporate status. In addition, although the recording unit 404 recorded attribute information of one affiliation as described above, the recording unit 404 is not limited thereto. For example, in a case in which the affiliation of the user of the camera 100 forms a hierarchical structure of a plurality of layers, attribute information of affiliations of the plurality of layers may be recorded by enumerating attribute information of affiliations of the plurality of layers. In addition, for example, in a case in which the user holds positions in a plurality of different departments, divisions, and the like, attribute information of the plurality of affiliations to which the user belongs may be recorded.

### Modification Example 2

In addition, the affiliation information storage unit 402 may store a change history (transfer history information) of attributes of affiliations, and may be configured so that historical information corresponding to the attribute information 631 of the affiliation and the image capturing time 640 of the image can be searched. Thereby, even in a case in which attributes of the affiliation of the user of the camera 100 have changed from the time of image capturing due to reorganization of the organization, attribute information of the affiliation at the time of image capturing can be acquired from information of the transfer history. In addition, by searching a process of changes of attributes of the affiliation, a source organization managing the image at a designated time point can be identified.

### Second Embodiment

In the First Embodiment, the recording unit 404 recorded attribute information that includes identification information of the affiliation of the user of the camera 100 in association with an image captured by the user of the camera 100. In a Second Embodiment, the recording unit 404 records personal identification information 632 that identifies an individual identity of the user of the camera 100 in addition to attribute information that includes identification information of the affiliation of the user of the camera 100. It should be noted that, since the configuration and each function unit in the camera 100 of the Second Embodiment are similar to the First Embodiment, explanations of points that are similar to the First Embodiment will be omitted hereinafter.

Hereinafter, processing performed by the camera 100 of the Second Embodiment will be explained with reference to FIG. 5. Each of the following processing is realized by the CPU 212 of the camera 100 executing a program stored in the memory unit 213. In addition, each step is denoted with “S” at the beginning, thereby omitting the notation of “step”. It should be noted that, in the Second Embodiment, since the processing of S510, S520, and S530 is similar to the First Embodiment, explanations thereof will be omitted.

In S540, the recording unit 404 records the image acquired in S510, personal identification information 632 of the user of the camera 100 identified in S520, and attribute information 631 of the affiliation of the user of the camera 100 identified in S530 to the memory unit 213. It should be noted that, similar to the First Embodiment, the recording unit 404 records the personal identification information 632 and the attribute information 631 of the affiliation in association with the image acquired in S510.

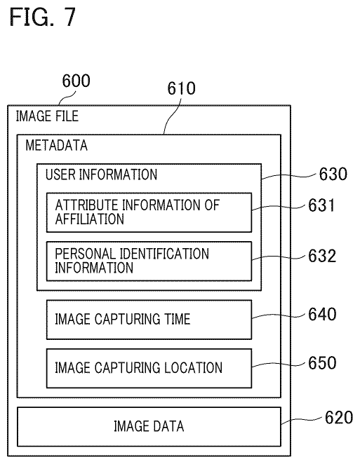

FIG. 7 is a diagram showing a configuration of data recorded by the recording unit 404 in the processing of S540 in the Second Embodiment. That is, FIG. 7 is a diagram showing the image file 600 recorded by the recording unit 404 in the Second Embodiment. In the Second Embodiment, as shown in FIG. 7, personal identification information 632 is added to the data configuration shown in FIG. 6 in the First Embodiment. Specifically, the user information 630 includes personal identification information 632 in addition to attribute information 631 of the affiliation of the user of the camera 100. Furthermore, similar to the First Embodiment, as shown in FIG. 7, the image file 600 may be recorded in a state wherein the metadata 610 includes information with respect to the image capturing time 640 and image capturing location 650.

As described above, the camera 100 having the information processing apparatus (CPU 212) of the Second Embodiment enables managing the image as information associated with the organization of the affiliation as well as managing the image as information associated with the user of the camera 100.

### Modification Example 1

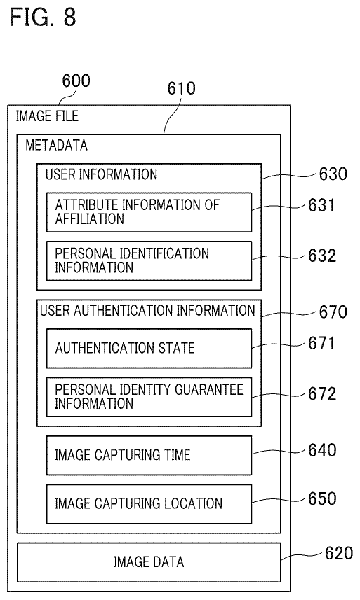

Information with respect to authentication of the user of the camera 100 may be added as information recorded by the recording unit 404. Hereinafter, an explanation will be provided with reference to FIG. 8. FIG. 8 is a diagram showing a structure of data recorded in the present modification example. In FIG. 8, user authentication information 670 is included in the metadata 610 in addition to the data configuration shown in FIG. 7.

The user authentication information 670 is configured by an authentication state 671 and identity guarantee information 672 of the user of the camera 100. The authentication state 671 is information indicating whether or not identity of the user of the camera 100 could be guaranteed. The recording unit 404 records ON for the authentication state in a case in which identity guarantee information corresponding to the user of the camera 100 identified by the user identification unit 401 is acquired from the memory unit 213, and records OFF in other cases. In addition, the identity guarantee information is information that publicly identifies an individual, such as a passport number. In this manner, the recording unit 404 records the authentication state 671 and the identity guarantee information 672 in association with the image acquired in S510 to the memory unit 213, in addition to personal identification information of the user of the camera 100 and attribute information of the affiliation of the user of the camera 100.

It should be noted that, in the data structure shown in FIG. 8, although both personal identification information 632 and identity guarantee information 672 are included in the metadata 610, in a case in which identity guarantee information 672 can be acquired, the identity guarantee information 672 may be recorded, and the personal identification information 632 may not be recorded. In addition, the authentication state 671 may be omitted from recording, and in a case in which identity guarantee information 672 cannot be acquired, the identity guarantee information 672 may not be recorded. In this manner, according to the present modification example, authenticity guarantee of an image captured by the camera 100 can be ensured.

### Third Embodiment

In the First Embodiment, attribute information that includes identification information of the affiliation of the user of the camera 100 was recorded in association with an image. In a Third Embodiment, a method of recording information (personal identification information) identifying individuals (members) belonging to the affiliation of the user of the camera 100, including the user of the camera 100, in association with an image will be explained. It should be noted that, since the configuration and each function unit in the camera 100 of the Third Embodiment are similar to the First Embodiment, explanations of points similar to the First Embodiment will be omitted.

In the Third Embodiment, the affiliation information storage unit 402 stores personal identification information of members belonging to the affiliation of the user of the camera 100, in addition to identification information of the affiliation of the user stored in association with personal identification information of the user of the camera 100. In addition, the recording unit 404 records personal identification information (individual identification information) of members other than the user belonging to the affiliation of the user of the camera 100, in addition to identification information of the user of the camera 100.

Hereinafter, processing performed by the camera 100 of the Third Embodiment will be explained with reference to FIG. 5. Each of the following processing is realized by the CPU 212 of the camera 100 executing a program stored in the memory unit 213. In addition, each step is denoted with “S” at the beginning, thereby omitting the notation of “step”. It should be noted that, in the Third Embodiment, since the processing of S510, S520, and S530 is similar to the First Embodiment, explanations thereof will be omitted.

In S540, the recording unit 404 records data that includes the image acquired in S510, personal identification information 632 of the user of the camera 100 identified in S520, and personal identification information 681 of members other than the user belonging to the affiliation of the user of the camera 100 to the memory unit 213. It should be noted that, similar to the First Embodiment, the recording unit 404 records personal identification information 632 and personal identification information 681 of members other than the user belonging to the affiliation of the user of the camera 100 in association with the image acquired in S510.

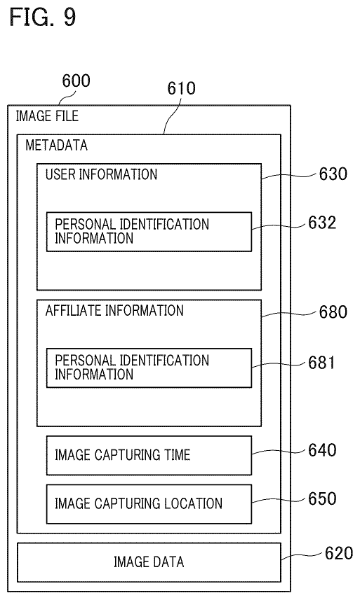

FIG. 9 is a diagram showing a structure of data recorded by the recording unit 404 in the Third Embodiment. That is, FIG. 9 is a diagram showing the image file 600 recorded by the recording unit 404 in the Third Embodiment. It should be noted that FIG. 9 shows an example in a case in which two persons belong to the affiliation of the user of the camera 100. Affiliate information 680 is information of members (affiliates) other than the user among members belonging to the affiliation of the user of the camera 100. Each affiliate information includes personal identification information 681, which is information identifying a member (an individual).

Furthermore, as shown in FIG. 9, similar to the First Embodiment, the image file 600 may be recorded in a state in which the metadata 610 includes information with respect to the image capturing time 640 and image capturing location 650.

As described above, the camera 100 having the information processing apparatus (CPU 212) of the Third Embodiment enables identification of persons related to a captured image from the image file 600 even in a situation in which a database and the like storing members of the affiliation cannot be accessed. Furthermore, even in a case in which there is a change or reorganization of the affiliation, or a change in members of the affiliation, persons involved with a captured image can be identified from the image file 600 without searching a history of the affiliation or members of the affiliation.

### Modification Example 1

In the Third Embodiment, personal identification information 632 of the user of the camera 100 and personal identification information 681 of members belonging to the affiliation of the user were recorded in association with an image. However, information recorded in association with an image is not limited thereto. For example, identity guarantee information may be recorded instead of personal identification information for both the user of the camera 100 and all members that belong to the affiliation of the user. Alternatively, both personal identification information and identity guarantee information may be recorded. In addition, for example, the recording unit 404 may combine information to be recorded according to situation and person, such as recording personal identification information and identity guarantee information of the user of the camera 100, and recording only personal identification information of the members.

### Modification Example 2

In the Modification Example 1 of the Third Embodiment described above, a method of recording personal identification information or identity guarantee information of all members of the affiliation of the user of the camera 100 in association with an image was shown. However, the target to be recorded need not be all members of the affiliation. For example, in addition to the user of the camera 100, personal identification information or identity guarantee information of a person in charge that is one of the members of the affiliation of the user may be recorded.

Alternatively, only for members that were involved in image capturing work of the image, personal identification information or identity guarantee information may be recorded. In this manner, it is possible to select at discretion which persons will have personal identification information or identity guarantee information recorded, rather than recording information of all members.

### Fourth Embodiment

In the Second Embodiment, a method was shown in which the recording unit 404 records identity guarantee information 672 that identifies individual identity of the user of the camera 100 in association with an image in addition to attribute information that includes identification information of the affiliation of the user. In this context, information with respect to authentication regarding the affiliation of the user of the camera 100 may be recorded by adding this authentication information. In a Fourth Embodiment, the affiliation information storage unit 402 stores identity guarantee information of the affiliation in association with identification information of the affiliation of the user of the camera 100. It should be noted that the identity guarantee information 691 of the affiliation of the user of the camera 100 is, for example, a corporate individual number (My Number) or an authentication number issued by registering with a certification authority. It should be noted that, since the configuration and each function unit and the like in the camera 100 of the Fourth Embodiment are similar to the First Embodiment, explanations with respect to points similar to the First Embodiment will be omitted.

Hereinafter, processing performed by the camera 100 of the Fourth Embodiment will be explained with reference to FIG. 5. Each of the following processing is realized by the CPU 212 of the camera 100 executing a program stored in the memory unit 213. In addition, each step is denoted with “S” at the beginning, thereby omitting the notation of “step”. It should be noted that, in the Fourth Embodiment, since the processing of S510, S520, and S530 is similar to the First Embodiment, explanations thereof will be omitted.

In S540, the recording unit 404 records data that includes the image acquired in S510, personal identification information 632 of the user of the camera 100 identified in S520, and attribute information 631 of the affiliation of the user of the camera 100 identified in S530 to the memory unit 213. In addition, the recording unit 404 records identity guarantee information 691 of the affiliation of the user of the camera 100 to the memory unit 213. It should be noted that similar to the First Embodiment, the recording unit 404 records the personal identification information 632, attribute information 631 of the affiliation, and identity guarantee information 691 of the affiliation in association with the image acquired in S510.

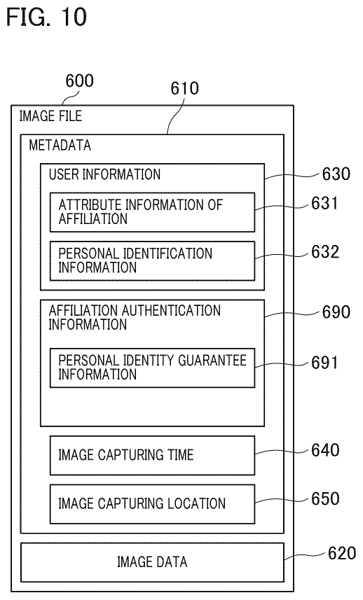

FIG. 10 is a diagram showing a structure of data recorded by the recording unit 404 in the Fourth Embodiment. That is, FIG. 10 is a diagram showing the image file 600 recorded by the recording unit 404 in the Fourth Embodiment. Affiliation authentication information 690 is information that publicly authenticates the affiliation of the user of the camera 100, and includes identity guarantee information 691 with respect to the affiliation of the user of the camera 100. Furthermore, as shown in FIG. 10, similar to the First Embodiment, the image file 600 may be recorded in a state in which the metadata 610 includes information with respect to the image capturing time 640 and image capturing location 650.

As described above, the camera 100 having the information processing apparatus (CPU 212) of the Fourth Embodiment enables authenticity guarantee of the source of rights to be ensured in a case in which the right to use a captured image exists at the affiliation of the user of the camera 100.

### Modification Example 1

In the Fourth Embodiment, both attribute information 631 of the affiliation of the user of the camera 100 and identity guarantee information 691 as affiliation authentication information 690 were recorded in association with an image. However, the present disclosure is not limited thereto, and for example, only identity guarantee information 691 may be recorded without recording attribute information 631 of the affiliation of the user of the camera 100.

### Modification Example 2

In addition, information of the affiliation of the user of the camera 100 to be recorded in association with an image may be made selectable from attribute information 631 of the affiliation and affiliation authentication information 690. For example, attribute information 631 of the affiliation is recorded in a case in which the target image is used within the affiliation, and affiliation authentication information 690 is recorded in a case in which the target image is disclosed outside the affiliation. According to the method of the present modification example, in a case in which there is no necessity for rights guarantee of the affiliation, the complexity of affiliation authentication acquisition and authentication information recording can be reduced.

### Modification Example 3

In addition, in a case in which the right to use an image was transferred between organizations, identity guarantee information 691 recorded in association with the image may be changed to identification information of the organization to which the right was transferred (updated to identity identification information of the destination of the right transfer). Alternatively, by using blockchain technology and the like, transfer history of the affiliation of affiliation authentication information 690 may be added to the image. According to the method of the present modification example, information of the destination of the right transfer of the image can be managed and updated by associating with the image.

### Fifth Embodiment

In the Fifth Embodiment, a user interface by which an image and attribute information of the affiliation recorded in association with the image are confirmable or editable will be explained. Screens of the user interface explained in the Fifth Embodiment are displayed on the operation member 103 of the camera 100. It should be noted that, since the configuration and each function unit and the like in the camera 100 of the Fifth Embodiment are similar to the First Embodiment, explanations of points similar thereto will be omitted.

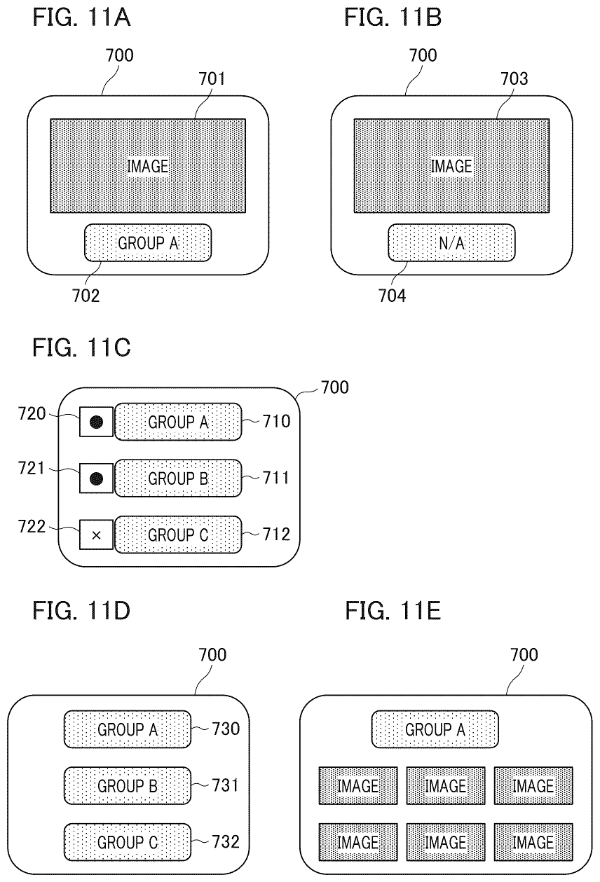

Hereinafter, the user interface of the Fifth Embodiment will be explained with reference to FIG. 11. FIG. 11 is a diagram showing an example of screens of the user interface displayed on the operation member 103 of the camera 100 according to the Fifth Embodiment.

FIG. 11A is a diagram showing an example of displaying an image and attribute information of the affiliation of the user of the camera 100 associated with the image on a screen of the operation member 103. A screen 700 is a screen displayed on the operation member (touch panel) 103. A display image 701 is an image displayed on the screen of the operation member 103. In a name display unit 702, a name of the affiliation of the user of the camera 100 associated with the display image 701 is displayed. It should be noted that the name display unit 702 is configured so as to be operable by touch operation. FIG. 11B is a diagram showing an example of displaying an image for which the affiliation of the user of the camera 100 is not set on a screen of the operation member 103. As shown in FIG. 11B, when an affiliation linked to the display image 703 is not set, a name of the affiliation displayed in a name display unit 704 is displayed in a state of “N/A”. It should be noted that the name display unit 704 is configured so as to be operable by touch operation.

FIG. 11C is a diagram exemplifying a screen for selecting an affiliation to be associated with an image. When the name display unit 702 or the name display unit 704 is touched, the screen of FIG. 11C is displayed. In a name display unit 710, a name display unit 711, and a name display unit 712, names of the affiliation of the user of the camera 100 recorded in the memory unit 213 and the like of the camera 100 are displayed. A user (user of the camera 100) can associate an affiliation with an image selected before displaying the screen 700 by touching any one of the name display units 710 to 712 that the user intends to register as the affiliation on the screen 700. In addition, in a frame 720, a frame 721, and a frame 722, marks indicating whether or not each of the affiliations is associated with any image are displayed.

Here, for example, in FIG. 11C, since a black dot, serving as a mark indicating that the affiliation is associated with an image, is displayed in the frame 720, it can be seen that the affiliation “Group A” is associated with any image. Furthermore, since a black dot is also displayed in the frame 721, similar to the affiliation “Group A”, it can be seen that the affiliation “Group B” is associated with any image. In contrast, since an x mark, serving as a mark indicating that the affiliation is not associated with an image, is displayed in the frame 722, the x mark indicates that the affiliation “Group C” is not associated with any image. It should be noted that, as described above, marks are not limited to black dots or x marks, and may be marks of other shapes such as white dots or triangles, and the like, and furthermore, may be displayed as characters or figures representing characters such as “OK” in a case in which the affiliation is associated with an image and “NO” in a case in which the affiliation is not associated with an image. Furthermore, the marks may be made judgeable by using colors, such as filling the inside of the frame with blue in a case in which the affiliation is associated with an image and filling the inside of the frame with red in a case in which the affiliation is not associated with an image, and these may be combined.

FIG. 11D and FIG. 11E are diagrams showing a user interface for confirming images with which an affiliation is associated. FIG. 11D is a group selection screen. When any one of a name display unit 730, a name display unit 731, and a name display unit 732 displayed on the screen shown in FIG. 11D is touched, one image or an image group configured by a plurality of images with which the touched affiliation is associated is displayed. That is, the screen transitions to a screen as shown in FIG. 11E. FIG. 11E is a screen on which a list of images with which the affiliation “Group A” is associated can be displayed. In the example shown in FIG. 11E, a name of the affiliation and an image group are displayed. As described above, each name display unit in the present embodiment is also a user interface that can be operated by touch operation.

In this manner, on the screen of the operation member 104 that is a touch panel, an image captured by the user of the camera 100 and the affiliation of the user of the camera 100 that the recording unit 404 recorded in association with the image are displayed. These processes related to the display control described above are executed by the CPU 212.

As described above, the camera 100 having the information processing apparatus (CPU 212) of the Fifth Embodiment enables visual confirmation of whether or not information of the affiliation of the user is appropriately recorded in an image captured by the camera. In addition, information of the affiliation of the user to be recorded in association with an image can be added or changed.

### Modification Example 1

Although in the above, an example of displaying a name among attribute information of the affiliation was shown, information to be displayed is not limited thereto, and may be any attribute information of the affiliation. For example, identification information of the affiliation may be displayed instead of the name. In addition, for example, identification information of the affiliation may be displayed in addition to the name. In this manner, on the screen of the operation member 104 that is a touch panel, an image captured by the user of the camera 100 and attribute information of the affiliation of the user of the camera 100 that the recording unit 404 recorded in association with the image may be displayed.

### Modification Example 2

In a case in which identity guarantee information of the affiliation of the user of the camera 100 is recorded in association with an image, the identity guarantee information that is recorded may be displayed so as to be visually recognizable. For example, the affiliation may be highlighted, or a predetermined mark may be displayed in the vicinity of the affiliation.

In each of the above-described embodiments, an example was shown in which processing shown in FIG. 5, that is, processing in each embodiment, is executed by the CPU 212 in the camera 100. However, the configuration of hardware is not limited thereto. For example, by causing a part or all of processing performed by the function units shown in FIG. 4 to operate on an external apparatus such as a PC or a server, and the like, or in the cloud, processing in each of the above-described embodiments that includes the processing shown in FIG. 5 can be realized.

The present disclosure can also be realized by processing in which a program for realizing one or more functions of the above-described embodiments is supplied to a system or an apparatus via a network or a storage medium, and one or more processors in a computer of the system or the apparatus reads out and executes the program. In addition, the present disclosure can also be realized by a circuit (for example, ASIC) that realizes one or more functions.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a “non-transitory computer-readable storage medium”) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-099350, filed on Jun. 20, 2024, which is hereby incorporated by reference herein in its entirety.

What is claimed is:

1. An information processing apparatus comprising:
at least one processor; and
at least one memory having stored thereon instructions that, when executed by the at least one processor, cause the information processing apparatus at least to:
identify a user that captured an image by using an image capturing apparatus;
identify an affiliation of the user and acquire attribute information of the affiliation of the user based on personal identification information that identifies individual identity of the user identified in the user identification; and
record the attribute information of the affiliation of the user in association with the image captured by the user.

2. The information processing apparatus according to claim 1, configured to acquire the image captured by the user and, in the user identification, identify as the user the person that captured the image acquired by using the image capturing apparatus.

3. The information processing apparatus according to claim 1, configured to identify the user based on registrant feature information recorded in association with personal identification information of a registrant registered in advance and user feature information acquired at a time of image capturing by using the image capturing apparatus.

4. The information processing apparatus according to claim 3, wherein the registrant feature information and the user feature information are information of a color pattern of an eyeball.

5. The information processing apparatus according to claim 1, configured to identify the user by using any one of authentication methods of biometric authentication by using eyeball information, fingerprint authentication, or password authentication.

6. The information processing apparatus according to claim 3, configured to determine, as personal identification information of the identified user, personal identification information linked to the registrant feature information of the registrant identified as the user; and
identify the affiliation of the user by searching a database that associates personal identification information of the registrant with attribute information of an affiliation based on the determined personal identification information of the user.

7. The information processing apparatus according to claim 1, further configured to store attribute information of the affiliation of persons that include the user and transfer history information of the affiliation.

8. The information processing apparatus according to claim 1, wherein attribute information of the affiliation of the user recorded in association with the image is information that uniquely identifies the affiliation of the user.

9. The information processing apparatus according to claim 1, wherein the attribute information of the affiliation of the user recorded in association with the image includes information identifying all or some of members of the affiliation of the user.

10. The information processing apparatus according to claim 1, further configured to record at least one of information of a time at which the image was captured and information of a location at which the image was captured in association with the image.

11. The information processing apparatus according to claim 1, further configured to record the personal identification information of the user in association with the image.

12. The information processing apparatus according to claim 1, further configured to record identity guarantee information that is information guaranteeing the genuine identity of the user, in association with the image.

13. The information processing apparatus according to claim 1, further configured to record identity guarantee information of the affiliation in association with the image.

14. The information processing apparatus according to claim 13, further configured to change the identity guarantee information of the affiliation recorded in association with the image to identification information at the destination of right transfer of the image in a case in which a right to use the image has been transferred.

15. The information processing apparatus according to claim 1, further configured to display the image and the attribute information of the affiliation of the user recorded in association with the image.

16. The information processing apparatus according to claim 1, further configured to cause to display the image and the attribute information of the affiliation of the user recorded in association with the image.

17. The information processing apparatus according to claim 1, further configured to associate the affiliation with the image or cause to display one or more images associated with the affiliation in a case in which a predetermined input operation is performed on a user interface displayed on a screen.

18. An information processing method comprising:
identifying a user that captured an image by using an image capturing apparatus;
identifying an affiliation of the user and acquiring attribute information of the affiliation of the user based on personal identification information that identifies individual identity of the user identified in the user identification; and
recording the attribute information of the affiliation of the user in association with the image captured by the user.

19. A non-transitory computer-readable storage medium storing a program that causes a computer to execute an information processing method, wherein the program causes the computer to:
identify a user that captured an image by using an image capturing apparatus;
identify an affiliation of the user and acquire attribute information of the affiliation of the user based on personal identification information that identifies individual identity of the user identified in the user identification; and
record the attribute information of the affiliation of the user in association with the image captured by the user.
